(19) United States
(12) Patent Application Publication
(10) Pub. No.: US 2022/0195150 A1
(43) Pub. Date: Jun. 23, 2022

(54) RUBBER COMPOSITION MANUFACTURING METHOD AND TIRE MANUFACTURING METHOD

(71) Applicant: Toyo Tire Corporation, Itami-shi (JP)

(72) Inventor: Sho Taniguchi, Itami-shi (JP)

(73) Assignee: Toyo Tire Corporation, Itami-shi (JP)

(21) Appl. No.: 17/534,532

(22) Filed: Nov. 24, 2021

(30) Foreign Application Priority Data
Dec. 21, 2020 (JP) 2020-211191

(51) Int. Cl. C08L 9/00; B29B 7/72; B29B 7/50; C08K 3/04; B29D 30/02; C08K 3/36

(52) U.S. Cl. CPC C08L 9/00; B29B 7/726; C08K 3/36; C08K 3/04; B29D 30/02; B29B 7/50

(57) ABSTRACT

A rubber composition manufacturing method in accordance with the present invention comprises an operation in which at least rubber, silica, and silane coupling agent are kneaded in an internal kneader while kneading temperature is controlled so as to suppress occurrence of a coupling reaction between the silica and the silane coupling agent, wherein for at least a portion of time during which the operation is being carried out, at least the rubber, the silica, and the silane coupling agent are kneaded while a ram of the internal kneader is in a nonpressing state.

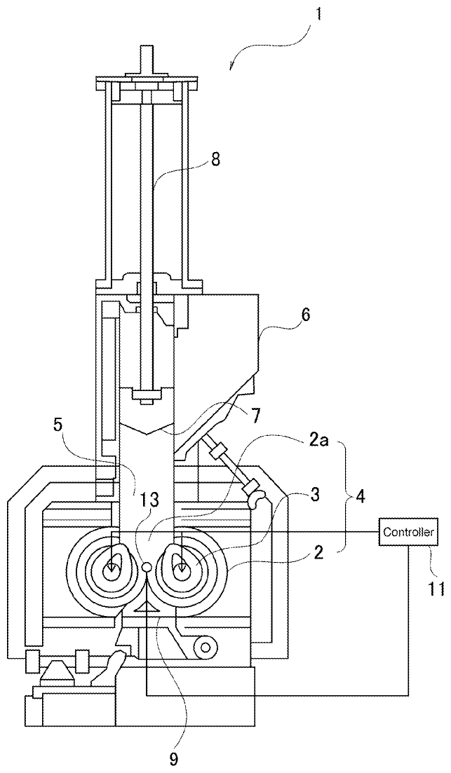

### TECHNICAL FIELD

The present invention relates to a rubber composition manufacturing method and a tire manufacturing method.

### BACKGROUND ART

Because silica which is employed as reinforcing filler in rubber possesses silanol groups, there is a tendency for flocculation to occur due to hydrogen bonding. It is therefore the case that silica cannot easily be satisfactorily dispersed. In particular, silica cannot easily be satisfactorily dispersed in situations such as when silica filler content is high, silica particle diameter is small, and so forth.

To decrease silica cohesive forces, use of silane coupling agent is known. Silane coupling agents can prevent flocculation of silica because they are capable of reacting with silica during kneading. Moreover, silane coupling agents can cause bonding of silica and rubber because they are capable of reacting with rubber double bonds during vulcanization.

To increase dispersion of silica, Patent Reference No. 1 describes using an internal kneader to knead rubber, silica, silane coupling agent, and so forth while controlling kneading temperature so as to suppress reaction (specifically coupling reaction) between silica and silane coupling agent.

### PRIOR ART REFERENCES

### Patent References

Patent Reference No. 1: Japanese Patent Application Publication Kokai No. 2020-100116

### SUMMARY OF INVENTION

### Problem to be Solved by Invention

While the method described at Patent Reference No. 1 permits increase in dispersion of silica and consequently permits improvement in performance with respect to braking on wet road surfaces (hereinafter “wet braking performance”) and in ability to achieve reduced heat generation in tires, this method still leaves room for improvement.

It is an object of the present invention to provide a method for manufacturing a rubber composition permitting improvement in wet braking performance and ability to achieve reduced heat generation in tires.

### Means for Solving Problem

To solve these problems, a rubber composition manufacturing method in accordance with the present invention comprises an operation in which at least rubber, silica, and silane coupling agent are kneaded in an internal kneader while kneading temperature is controlled so as to suppress occurrence of a coupling reaction between the silica and the silane coupling agent, wherein

the internal kneader is equipped with a kneading chamber, a neck portion which is located above the kneading chamber, and a ram which is capable of moving vertically through a space within the neck portion; and

for at least a portion of time during which the operation is being carried out, at least the rubber, the silica, and the silane coupling agent are kneaded while the ram is in a nonpressing state.

Where it is said here that “the ram is in a nonpressing state,” this includes states in which the ram is raised to an extent such as will cause at least a portion of the kneading chamber to constitute an open system.

In accordance with the present invention, by causing kneading to be carried out while kneading temperature is controlled so as to suppress occurrence of the coupling reaction, it will be possible to achieve effective dispersal of silica before the coupling reaction reaches the point where it is proceeding vigorously. As a result, where the coupling reaction is made to proceed after that operation, because it will be possible to increase the efficiency with which the coupling reaction takes place, this will make it possible to effectively reduce silica cohesive forces. It will therefore be possible to improve wet braking performance and ability to achieve reduced heat generation in tires.

Moreover, because causing kneading to be carried out while in a nonpressing state (which includes states in which at least a portion of the kneading chamber constitutes an open system) for at least a portion of the time during which that operation (specifically, the operation in which kneading is carried out while kneading temperature is controlled so as to suppress occurrence of the coupling reaction) is being carried out will make it possible for moisture and/or other such volatile substances to be discharged to the exterior of the kneading chamber, this will make it possible to reduce slippage of rotor(s) that might otherwise occur due to presence of moisture. It will therefore be possible to even further increase the extent to which dispersal of silica occurs before the coupling reaction reaches the point where it is proceeding vigorously. In addition, whereas there will be supplemental generation of water during the course of the coupling reaction, where the coupling reaction is made to proceed after that operation (specifically, the operation in which kneading is carried out while kneading temperature is controlled so as to suppress occurrence of the coupling reaction), because it will be possible to cause the coupling reaction to proceed under conditions in which there is reduced moisture content, this will make it possible to cause the coupling reaction to proceed with good efficiency As a result of the foregoing, it will be possible to improve wet braking performance and ability to achieve reduced heat generation in tires.

In particular, where rotor rotational speed is subjected to PID control at that operation (specifically, the operation in which kneading is carried out while kneading temperature is controlled so as to suppress occurrence of the coupling reaction), the present invention will make it possible to effectively improve wet braking performance and ability to achieve reduced heat generation in tires. Description will be given with respect to this. If, during PID control of the rotor, kneading were to be carried out only while in a pressing state (specifically, a state in which material that is in the process of being kneaded is pressed on by the ram), because generation of heat due to shearing would tend to lead to an increase in temperature, this would tend to cause the rotational speed of the rotor to decrease, and would accordingly tend to impede dispersal of silica (specifically, dispersal of silica before the coupling reaction proceeds). In contradistinction thereto, because causing kneading to be carried out while in a nonpressing state in accordance with the present invention makes it possible for kneading to be carried out while in a state in which it is less likely that temperature will increase than would be the case were this in a pressing state, this makes it possible to suppress reduction in the rotational speed of the rotor that might otherwise occur. As a result, it will be possible to even further increase the extent to which dispersal of silica occurs before the coupling reaction reaches the point where it is proceeding vigorously. It will therefore be the case, where the coupling reaction is made to proceed after that operation (specifically, the operation in which kneading is carried out while kneading temperature is controlled so as to suppress occurrence of the coupling reaction), that it will be possible to increase the efficiency with which the coupling reaction takes place, as a result of which it will be possible to effectively reduce silica cohesive forces. It will therefore be possible to effectively improve wet braking performance and ability to achieve reduced heat generation in tires.

It is preferred that the constitution of the rubber composition manufacturing method of the present invention be such that the portion of time is not less than 10 seconds. That is, it is preferred that the constitution be such that kneading be carried out while in a nonpressing state for not less than 10 seconds during that operation (specifically, the operation in which kneading is carried out while kneading temperature is controlled so as to suppress occurrence of the coupling reaction).

By causing this to be not less than 10 seconds, it will be possible to effectively decrease the amount of moisture within the kneading chamber. It will therefore be possible to effectively increase dispersal of silica (specifically, dispersal of silica before the coupling reaction proceeds). In addition, where the coupling reaction is made to proceed after that operation (specifically, the operation in which kneading is carried out while kneading temperature is controlled so as to suppress occurrence of the coupling reaction), it will therefore be possible to effectively increase the efficiency with which the coupling reaction takes place.

It is preferred that the constitution of the rubber composition manufacturing method of the present invention be such that the internal kneader is equipped with a rotor at the kneading chamber; and at the operation (specifically, the operation in which kneading is carried out while kneading temperature is controlled so as to suppress occurrence of the coupling reaction), rotational speed of the rotor is controlled by means of PID control to cause the kneading temperature to be a target temperature.

This constitution, i.e., causing the rotational speed of the rotor to be subjected to PID control, will make it possible to effectively improve wet braking performance and ability to achieve reduced heat generation in tires. Description will be given with respect to this. If, during PID control of the rotor, kneading were to be carried out only while in a pressing state (specifically, a state in which material that is in the process of being kneaded is pressed on by the ram), because generation of heat due to shearing would tend to lead to an increase in temperature, this would tend to cause the rotational speed of the rotor to decrease, and would accordingly tend to impede dispersal of silica (specifically, dispersal of silica before the coupling reaction proceeds). In contradistinction thereto, because causing kneading to be carried out while in a nonpressing state in accordance with the present invention makes it possible for kneading to be carried out while in a state in which it is less likely that temperature will increase than would be the case were this in a pressing state, this makes it possible to suppress reduction in the rotational speed of the rotor that might otherwise occur. As a result, it will be possible to effectively increase dispersal of silica (specifically, dispersal of silica before the coupling reaction proceeds). It will therefore be possible to improve wet braking performance and ability to achieve reduced heat generation in tires.

It is preferred that the constitution of the rubber composition manufacturing method of the present invention be such that it further comprises an operation in which kneading is carried out while kneading temperature is controlled so as to cause the coupling reaction to proceed.

Because causing kneading to be carried out while kneading temperature is controlled so as to cause the coupling reaction to proceed will make it possible to cause the coupling reaction to proceed vigorously while the silica is in a dispersed state, this will make it possible to increase the efficiency with which the coupling reaction takes place, and will consequently make it possible to effectively reduce silica cohesive forces. Accordingly, because it will be possible to effectively increase dispersal of silica, it will be possible to improve wet braking performance and ability to achieve reduced heat generation in tires.

A tire manufacturing method in accordance with the present invention comprises an operation in which the rubber composition manufacturing method of the present invention is used to prepare the rubber composition; and an operation in which the rubber composition is used to fabricate an unvulcanized tire.

### BRIEF DESCRIPTION OF DRAWINGS

The Figure is a conceptual diagram showing constitution of internal kneader capable of being used in accordance with the present embodiment.

### EMBODIMENTS FOR CARRYING OUT INVENTION

Below, description is given with respect to embodiments of the present invention.

### 1. Internal Kneader

Description will first be given with respect to an internal kneader capable of being used in accordance with the present embodiment.

As shown in the Figure, internal kneader 1 is equipped with kneading chamber 4 which has casing 2 and rotor 3; neck portion 5 which is located above kneading chamber 4 and which has a cylindrical space at the interior thereof; inlet port 6 which is provided at neck portion 5; ram 7 which is capable of moving vertically within the cylindrical space of neck portion 5; and drop door 9 which is located at the bottom of kneading chamber 4. As internal kneader 1, intermeshing internal kneaders, tangential internal kneaders, and the like may be cited as examples.

Opening portion 2a is provided in a central region at the top face of casing 2. Neck portion 5 which has the cylindrical space at the interior thereof is provided above opening portion 2a. Inlet port 6, by way of which rubber and compounding ingredients can be fed thereinto, is provided at the side face of neck portion 5. Two or more inlet ports 6 may be provided. Rubber and compounding ingredients fed thereinto from inlet port 6 pass through the cylindrical space at neck portion 5 and are fed into the interior of casing 2 by way of opening portion 2a of casing 2.

Ram 7 is of such shape as to be capable of closing off opening portion 2a of casing 2. By virtue of shaft 8 which is connected thereto at the top end thereof, ram 7 is made capable of moving vertically within the cylindrical space of neck portion 5. Under the force of its own weight and/or as a result of a pressing force that acts thereon from shaft 8, ram 7 is able to press on and compress rubber that is present within casing 2.

Drop door 9 is closed during kneading. Drop door 9 opens following termination of kneading.

The rotational speed of a motor (not shown) which causes rotor 3 to rotate is adjusted based on control signals from controller 11. Controller 11 carries out control of the rotational speed of the motor based on information (more specifically, measured temperature Tp) regarding the temperature within kneading chamber 4 which is sent thereto from temperature sensor 13. The motor can be made to be of variable rotational speed by virtue of controller 11. The motor might, for example, be an inverter-duty motor.

To determine the rotational speed of the motor, a PID arithmetic unit provided within controller 11 carries out proportional (P), integral (I), and differential (D) arithmetic operations based on the deviation between target temperature Ts and temperature Tp measured within kneading chamber 4 as detected by temperature sensor 13. More specifically, the PID arithmetic unit determines motor rotational speed from the sum of respective control quantities obtained as a result of proportional (P) action by which a control quantity is calculated in proportion to the difference (deviation e) between measured temperature Tp and target temperature Ts, integral (I) action by which a control quantity is calculated from an integral obtained by integrating the deviation e over time, and differential (D) action by which a control quantity is calculated from the slope of the change in, i.e., the derivative of, deviation e. Note that PID is an abbreviation for Proportional Integral Differential.

### 2. Respective Rubber Composition Manufacturing Method Operations

Description will next be given with respect to some of the operations which are included in a method for manufacturing a rubber composition in accordance with the present embodiment.

A method for manufacturing a rubber composition in accordance with the present embodiment comprises an operation (hereinafter “Operation S1”) in which a rubber mixture is prepared; and an operation (hereinafter “Operation S2”) in which at least the rubber mixture and a vulcanizing-type compounding ingredient are kneaded to obtain a rubber composition.

2.1 Operation S1 (Operation in which Rubber Mixture Is Prepared)

Operation S1 comprises an operation (hereinafter “Operation K1”) in which at least rubber, silica, and silane coupling agent are kneaded in internal kneader 1 while the kneading temperature is controlled so as to suppress occurrence of a coupling reaction (a reaction between silica and silane coupling agent); an operation (hereinafter “Operation K2”) which is carried out thereafter and in which kneading is carried out at internal kneader 1 while the kneading temperature is increased; and an operation (hereinafter “Operation K3”) which is carried out thereafter and in which kneading is carried out at internal kneader 1 while the kneading temperature is controlled so as to cause the coupling reaction to proceed.

Operations K1 through K3 constitute a single kneading stage. A kneading stage is the cycle that takes place from the time that material(s) are fed into internal kneader 1 until the time that discharge occurs therefrom. Materials, such as rubber, silica, and silane coupling agent therefore remain undischarged from internal kneader 1 at the time of the transition from Operation K1 to Operation K2, and the materials likewise remain undischarged from internal kneader 1 at the time of the transition from Operation K2 to Operation K3.

2.1.1. Operation K1 (Operation in which Kneading Is Carried Out So as To Suppress Occurrence of Coupling Reaction)

At this Operation K1, at least rubber, silica, and silane coupling agent are fed into internal kneader 1, and these are kneaded while the kneading temperature is controlled so as to suppress occurrence of a coupling reaction (a reaction between silica and silane coupling agent). By carrying out Operation K1, it is possible to achieve effective dispersal of silica before the coupling reaction reaches the point where it is proceeding vigorously. In addition, presence of Operation K1 also makes it possible to reduce the amount of electric power that must be consumed to manufacture the rubber composition. Description will be given with respect to this. Were the kneading temperature not controlled at Operation K1, then because kneading time would be limited due to the increase in temperature which would occur as a result of the heat generated from shearing, there would be great need to carry out rekneading multiple times (and such need would be all the more great where a high silica filler content is to be blended therein). In contradistinction thereto, because by controlling kneading temperature at Operation K1 the present embodiment makes it possible to eliminate limits on kneading time that would otherwise be imposed due to increase in temperature, it is possible to increase kneading time, and it is accordingly possible to reduce the number of times that rekneading must be carried out. As a result, it is possible to reduce the amount of electric power that must be consumed to manufacture the rubber composition.

As the rubber, natural rubber, polyisoprene rubber, styrene-butadiene rubber (SBR), polybutadiene rubber (BR), nitrile rubber, chloroprene rubber, and so forth may be cited as examples. One or any desired combination may be chosen from thereamong and used. It is preferred that the rubber be diene rubber.

A modified rubber may be used as the rubber. As modified rubber, modified SBR and modified BR may be cited as examples. The modified rubber may possess functional group(s) that contain heteroatom(s). While functional group(s) may be introduced at end(s) of polymer chain(s) or in mid-chain, it is preferred that they be introduced at end(s) thereof. As functional group(s), amino groups, alkoxyl groups, hydroxyl groups, carboxyl groups, epoxy groups, cyano groups, halogen atoms, and so forth may be cited as examples. Of these, amino groups, alkoxyl groups, hydroxyl groups, and carboxyl groups are preferred. The modified rubber may possess at least one of the types of functional groups that were cited as examples. As amino group(s), primary amino groups, secondary amino groups, tertiary amino groups, and so forth may be cited as examples. As alkoxyl group(s), methoxy groups, ethoxy groups, propoxy groups, butoxy groups, and so forth may be cited as examples. The functional groups that were cited as examples interact with silanol groups (Si—OH) of silica. Here, “interaction” means, for example, that there is formation of a hydrogen bond or a chemical bond caused by chemical reaction with a silanol group of silica. The amount of modified rubber might be not less than 10 mass %, might be not less than 20 mass %, or might be not less than 30 mass %, per 100 mass % of the rubber used at Operation K1. The amount of modified rubber might be not greater than 90 mass %, might be not greater than 80 mass %, or might be not greater than 70 mass %, per 100 mass % of the rubber used at Operation K1.

As silica, wet silica and dry silica may be cited as examples. Of these, wet silica is preferred. As wet silica, precipitated silica may be cited as example. Specific surface area of silica as determined by nitrogen adsorption might be not less than 80 m²/g, or it might be not less than 120 m²/g, or it might be not less than 140 m²/g, or it might be not less than 160 m²/g, for example. Specific surface area of silica might be not greater than 300 m²/g, or it might be not greater than 280 m²/g, or it might be not greater than 260 m²/g, or it might be not greater than 250 m²/g, for example. Here, the specific surface area of silica is measured in accordance with the multipoint nitrogen adsorption method (BET method) described at JIS K-6430.

It is preferred at Operation K1 that the amount of silica be not less than 10 parts by mass, more preferred that this be not less than 30 parts by mass, still more preferred that this be not less than 50 parts by mass, still more preferred that this be not less than 70 parts by mass, and still more preferred that this be not less than 80 parts by mass, per 100 parts by mass of rubber. It is preferred that the amount of silica be not greater than 150 parts by mass, more preferred that this be not greater than 140 parts by mass, still more preferred that this be not greater than 130 parts by mass, and still more preferred that this be not greater than 120 parts by mass, per 100 parts by mass of rubber.

As silane coupling agent, bis(3-triethoxysilylpropyl)tetrasulfide, bis(3-triethoxysilylpropyl)disulfide, bis(2-triethoxysilylethyl)tetrasulfide, bis(4-triekitoshisilylbutyl)disulfide, bis(3-trimethoxysilylpropyl)tetrasulfide, bis(2-trimethoxysilylethyl)disulfide, and other such sulfide silanes, γ-mercaptopropyltrimethoxysilane, γ-mercaptopropyltriethoxysilane, mercaptopropylmethyldimethoxysilane, mercaptopropyldimethylmethoxysilane, mercaptoethyltriethoxysilane, and other such mercaptosilanes, 3-octanoylthio-l-propyltriethoxysilane, 3-propionylthiopropyltrimethoxysilane, and other such protected mercaptosilanes may be cited as examples. One or any desired combination may be chosen from thereamong and used.

At Operation K1, it is preferred that the amount of silane coupling agent be not less than 1 part by mass, more preferred that this be not less than 3 parts by mass, and still more preferred that this be not less than 5 parts by mass, per 100 parts by mass of silica. The upper limit of the range in values for the amount of silane coupling agent might be 20 parts by mass, or might be 15 parts by mass, per 100 parts by mass of silica, for example.

At Operation K1, carbon black, antioxidant, stearic acid, wax, zinc oxide, oil, and/or the like may be kneaded together with the rubber, silica, and silane coupling agent. One or any desired combination may be chosen from thereamong and used.

As examples of carbon black, besides SAF, ISAF, HAF, FEF, GPF, and/or other such furnace blacks, acetylene black, Ketchen black, and/or other such electrically conductive carbon blacks may be used. The carbon black may be nongranulated carbon black or may be granulated carbon black that has been granulated based upon considerations related to the handling characteristics thereof. Any one thereamong may be used, or any two or more thereamong may be used.

As antioxidant, aromatic-amine-type antioxidant, amine-ketone-type antioxidant, monophenol-type antioxidant, bisphenol-type antioxidant, polyphenol-type antioxidant, dithiocarbamate-type antioxidant, thiourea-type antioxidant, and the like may be cited as examples. One or any desired combination may be chosen from thereamong and used as the antioxidant.

At Operation K1, kneading is carried out so as to cause the kneading temperature to be held constant. Where it is said that “the kneading temperature is held constant,” this means that the kneading temperature is maintained within a constant range. More specifically, at Operation K1, kneading is carried out so as to cause measured temperature Tp to be maintained at target temperature Ts. At such time, measured temperature Tp may be maintained so as to be within ±5° C. of target temperature Ts. Target temperature Ts might be less than 140° C., or might be not greater than 138° C., or might be not greater than 135° C., or might be not greater than 132° C., or might be not greater than 130° C. It is preferred that target temperature Ts be not less than 100° C., more preferred that this be not less than 110° C., still more preferred that this be not less than 115°, and still more preferred that this be not less than 120°. Where this is too low, there is a tendency for it to take a long time for silica to be dispersed. Note that target temperature Ts may be chosen as appropriate in light of the blend employed, and especially in light of the type(s) of silane coupling agent(s) employed.

At Operation K1, kneading is carried out so as to cause the kneading temperature to be maintained within a constant range for not less than 10 seconds. It is preferred that this be not less than 20 seconds, more preferred that this be not less than 40 seconds, still more preferred that this be not less than 60 seconds, and still more preferred that this be not less than 70 seconds. This might be not greater than 1000 seconds, or this might be not greater than 800 seconds, or this might be not greater than 600 seconds, or this might be not greater than 400 seconds, or this might be not greater than 200 seconds, or this might be not greater than 100 seconds.

The kneading temperature is maintained by carrying out adjustment of the rotational speed of rotor 3. More specifically, the kneading temperature is maintained by virtue of the fact that the rotational speed of rotor 3 is adjusted by means of PID control. Here, the rotational speed of rotor 3 is adjusted by means of PID control so as to cause measured temperature Tp to be target temperature Ts. PID control may commence at the start of kneading, or may commence when measured temperature Tp reaches some prescribed temperature.

For at least a portion of the time during Operation K1, at least the rubber, silica, and silane coupling agent are kneaded while ram 7 is in a state in which it is not pressing thereon (i.e., a nonpressing state; which includes states in which at least a portion of kneading chamber 4 constitutes an open system). Because this (specifically, carrying out kneading while in a nonpressing state) makes it possible for moisture and/or other such volatile substances to be discharged to the exterior, it permits reduction in slippage of rotor 3 that might otherwise occur due to presence of moisture. It will therefore be possible to even further increase the extent to which dispersal of silica occurs before the coupling reaction reaches the point where it is proceeding vigorously. In addition, whereas there will be supplemental generation of water during the course of the coupling reaction that takes place at Operation K3, because it will be possible to cause the coupling reaction to proceed under conditions in which there is reduced moisture content, this will make it possible to cause the coupling reaction to proceed with good efficiency. As a result of the foregoing, it will be possible to improve wet braking performance and ability to achieve reduced heat generation in tires.

The nonpressing state may be sustained, i.e., continuous, or it may be intermittent. A sustained nonpressing state might be created, for example, by maintaining ram 7 in a raised state. An intermittent nonpressing state might be created, for example, by causing ram 7 to be repeatedly lowered and raised.

Kneading while in nonpressing state(s) is carried out during the middle phase and/or final phase of Operation K1. That is, during the middle phase and/or final phase of Operation K1, kneading is carried out while in nonpressing state(s). The reason for this is that whereas there is a tendency for the rotational speed of rotor 3 to decrease due to the fact that there is a greater tendency for temperature to increase during the middle phase and final phase of Operation K1 than during the initial phase of Operation K1, causing kneading to be carried out while in a nonpressing state (i.e., carrying out kneading while in a state in which there is less tendency for temperature to increase) during the middle phase and/or final phase of Operation K1 will make it possible to suppress reduction that might otherwise occur in the rotational speed of rotor 3. On the other hand, it is preferred that kneading be carried out while in a pressing state during the initial phase of Operation K1.

It is preferred that the time during which the nonpressing state exists be not less than 10 seconds, more preferred that this be not less than 30 seconds, and still more preferred that this be not less than 50 seconds. Causing this to be not less than 10 seconds will make it possible to effectively reduce the moisture content within kneading chamber 4. Accordingly, it will be possible to effectively increase dispersal of silica (specifically, dispersal of silica before the coupling reaction proceeds), and it will be possible to effectively increase the efficiency of the coupling reaction at Operation K3. Note that where the nonpressing state is intermittent, “the time during which the nonpressing state exists” means the total time occupied by nonpressing states.

As has already been explained, whereas the rotational speed of rotor 3 is adjusted by means of PID control so as to cause the kneading temperature to be target temperature Ts during Operation K1, this (specifically, control of the rotational speed of rotor 3 by means of PID control) makes it possible to effectively improve wet braking performance and ability to achieve reduced heat generation in tires. Description will be given with respect to this. If, during PID control of rotor 3, kneading were to be carried out only while in a pressing state (specifically, a state in which material that is in the process of being kneaded is pressed on by ram 7), because generation of heat due to shearing would tend to lead to an increase in temperature, this would tend to cause the rotational speed of rotor 3 to decrease, and would accordingly tend to impede dispersal of silica (specifically, dispersal of silica before the coupling reaction proceeds). In contradistinction thereto, because causing kneading to be carried out while in a nonpressing state in accordance with the present embodiment makes it possible for kneading to be carried out while in a state in which it is less likely that temperature will increase than would be the case were this in a pressing state, this makes it possible to suppress reduction in the rotational speed of rotor 3 that might otherwise occur. As a result, it will be possible to effectively increase dispersal of silica (specifically, dispersal of silica before the coupling reaction proceeds). It will therefore be possible to improve wet braking performance and ability to achieve reduced heat generation in tires.

2.1.2. Operation K2 (Operation in which Kneading Is Carried Out as Kneading Temperature Is Increased)

At Operation K2, kneading is carried out while the kneading temperature is increased. At Operation K2, the kneading temperature is increased to a temperature at which the coupling reaction proceeds vigorously (e.g., 140° C. or higher). More specifically, the kneading temperature is increased to target temperature Ts for Operation K3. Moreover, at Operation K2, it is possible for kneading to occur while in a state in which material that is in the process of being kneaded is pressed on by ram 7, i.e., while in a pressing state.

2.1.3. Operation K3 (Operation in which Kneading Is Carried Out So as To Cause

Coupling Reaction To Proceed)

At Operation K3, kneading is carried out while kneading temperature is controlled so as to cause the coupling reaction (reaction between silica and silane coupling agent) to proceed. Because Operation K3 makes it possible to cause the coupling reaction to proceed vigorously while the silica is in a dispersed state, this makes it possible to increase the efficiency with which the coupling reaction takes place, and consequently makes it possible to effectively reduce silica cohesive forces. Accordingly, because it is possible to effectively increase dispersal of silica, it will be possible to improve wet braking performance and ability to achieve reduced heat generation in tires. In addition, presence of Operation K3 also makes it possible to reduce the amount of electric power that must be consumed to manufacture the rubber composition. Description will be given with respect to this. Were the kneading temperature not controlled at Operation K3, then because kneading time would be limited due to the increase in temperature which would occur as a result of the heat generated from shearing, there would be great need to carry out rekneading multiple times (and such need would be all the more great where a high silica filler content is to be blended therein). In contradistinction thereto, because by controlling kneading temperature at Operation K3 the present embodiment makes it possible to eliminate limits on kneading time that would otherwise be imposed due to increase in temperature, it is possible to increase kneading time, and it is accordingly possible to reduce the number of times that rekneading must be carried out. As a result, it is possible to reduce the amount of electric power that must be consumed to manufacture the rubber composition. Moreover, at Operation K3, it is possible for kneading to occur while in a state in which material that is in the process of being kneaded is pressed on by ram 7, i.e., while in a pressing state.

At Operation K3, kneading is carried out so as to cause the kneading temperature to be held constant. Where it is said that “the kneading temperature is held constant,” this means that the kneading temperature is maintained within a constant range. More specifically, at Operation K3, kneading is carried out so as to cause measured temperature Tp to be maintained at target temperature Ts. At such time, measured temperature Tp may be maintained so as to be within ±5° C. of target temperature Ts. Target temperature Ts might be not less than 140° C., or might be not less than 142° C., or might be not less than 145° C., or might be not less than 148° C., or might be not less than 150° C. Where this is too low, there is a tendency for it to take too long a time for the coupling reaction to proceed. It is preferred that target temperature Ts be not greater than 170° C., more preferred that this be not greater than 165° C., still more preferred that this be not greater than 160°, still more preferred that this be not greater than 155°, and still more preferred that this be not greater than 153°. Where this is too high, it is sometimes the case that there will be gel formation.

At Operation K3, kneading is carried out so as to cause the kneading temperature to be maintained within a constant range for not less than 20 seconds. It is preferred that this be not less than 40 seconds, more preferred that this be not less than 60 seconds, and still more preferred that this be not less than 80 seconds. This might be not greater than 2000 seconds, or this might be not greater than 1500 seconds, or this might be not greater than 1000 seconds, or this might be not greater than 500 seconds, or this might be not greater than 300 seconds, or this might be not greater than 200 seconds.

Note that, as was the case at Operation K1, the kneading temperature is maintained by carrying out adjustment of the rotational speed of rotor 3.

Thereafter, where necessary, kneading may be continued to be carried out until a prescribed discharge temperature is reached, drop door 9 may be opened, and the rubber mixture may be discharged.

### 2.1.4. Miscellaneous

Where necessary, the rubber mixture may be subjected to further kneading for improvement of silica dispersal characteristics and/or reduction in Mooney viscosity. In other words, rekneading thereof may be carried out.

As a result of a procedure such as the foregoing, a rubber mixture may be obtained.

2.2. Operation S2 (Operation in which Rubber Mixture and Vulcanizing-Type

Compounding Ingredient Are Kneaded to Obtain Rubber Composition)

At Operation S2, at least the rubber mixture and a vulcanizing-type compounding ingredient are kneaded to obtain a rubber composition. As examples of the vulcanizing-type compounding ingredient, sulfur, organic peroxides, and other such vulcanizing agents, vulcanization accelerators, vulcanization accelerator activators, vulcanization retarders, and so forth may be cited. One or any desired combination may be chosen from thereamong and used as the vulcanizing-type compounding ingredient. As examples of the sulfur, powdered sulfur, precipitated sulfur, insoluble sulfur, high dispersing sulfur, and the like may be cited. One or any desired combination may be chosen from thereamong and used as the sulfur. As examples of the vulcanization accelerators, sulfenamide-type vulcanization accelerators, thiuram-type vulcanization accelerators, thiazole-type vulcanization accelerators, thiourea-type vulcanization accelerators, guanidine-type vulcanization accelerators, dithiocarbamate-type vulcanization accelerators, and so forth may be cited. One or any desired combination may be chosen from thereamong and used as the vulcanization accelerator. Kneading may be carried out using a kneader. As the kneader, internal kneaders, open roll mills, and the like may be cited as examples. As an internal kneader, Banbury mixers, kneaders, and the like may be cited as examples.

It is preferred that the amount of silica in the rubber composition be not less than 10 parts by mass, more preferred that this be not less than 30 parts by mass, still more preferred that this be not less than 50 parts by mass, still more preferred that this be not less than 70 parts by mass, and still more preferred that this be not less than 80 parts by mass, per 100 parts by mass of rubber. It is preferred that the amount of silica be not greater than 150 parts by mass, more preferred that this be not greater than 140 parts by mass, still more preferred that this be not greater than 130 parts by mass, and still more preferred that this be not greater than 120 parts by mass, per 100 parts by mass of rubber.

It is preferred that the amount of silane coupling agent in the rubber composition be not less than 1 part by mass, more preferred that this be not less than 3 parts by mass, and still more preferred that this be not less than 5 parts by mass, per 100 parts by mass of silica. The upper limit of the range in values for the amount of silane coupling agent might be 20 parts by mass, or might be 15 parts by mass, per 100 parts by mass of silica, for example.

The rubber composition may further comprise carbon black, antioxidant, stearic acid, wax, zinc oxide, oil, sulfur, vulcanization accelerator, and/or the like. The rubber composition may comprise one or any desired combination thereamong. It is preferred that the amount of the sulfur, expressed as equivalent sulfur content, be 0.5 part by mass to 5 parts by mass for every 100 parts by mass of rubber. It is preferred that the amount of the vulcanization accelerator be 0.1 part by mass to 5 parts by mass for every 100 parts by mass of rubber.

The rubber composition may be used to fabricate a tire. More specifically, it is capable of being used in fabricating tire member(s) making up a tire. For example, the rubber composition may be used in fabricating tread rubber, sidewall rubber, chafer rubber, bead filler rubber, and/or the like. The rubber composition may be used to fabricate one or any desired combination among such tire member(s).

### 3. Respective Operations at Tire Manufacturing Method

Description will next be given with respect to some of the operations which are included in a method for manufacturing a tire in accordance with the present embodiment. Of these operations, note that operations for preparing a rubber composition have already been described.

A tire manufacturing method in accordance with the present embodiment comprises an operation in which a rubber composition is used to fabricate an unvulcanized tire. This operation comprises fabrication of tire member(s) which comprise a rubber composition(s), and fabrication of an unvulcanized tire which is equipped with the tire member(s). As tire member(s), tread rubber, sidewall rubber, chafer rubber, and bead filler rubber may be cited as examples. Thereamong, tread rubber is preferred.

The tire manufacturing method in accordance with the present embodiment may further comprise an operation in which the unvulcanized tire is vulcanized and molded. The tire obtained in accordance with the method of the present embodiment may be a pneumatic tire.

### Various Modifications May Be Made to the Foregoing Embodiment

Various modifications may be made to the foregoing embodiment. For example, modifications which may be made to the foregoing embodiment might include any one or more variations chosen from among the following.

The foregoing embodiment was described in terms of a constitution in which the total amount of silica is fed thereinto during a kneading stage comprising Operations K1 through K3. However, the foregoing embodiment is not limited to this constitution. For example, feeding of silica thereinto may be divided among a plurality of kneading stages.

The foregoing embodiment was described in terms of a constitution in which control of kneading temperature is carried out by means of the rotational speed of rotor 3 at Operation K1. However, the foregoing embodiment is not limited to this constitution. For example, control of kneading temperature may be carried out by means of the temperature of a heating/cooling medium that flows through a jacket (not shown) at internal kneader 1.

The foregoing embodiment was described in terms of a constitution in which control of kneading temperature is carried out based on PID control at Operation K1. However, the foregoing embodiment is not limited to this constitution. Control of kneading temperature may be carried out based on a control method other than PID control.

The foregoing embodiment was described in terms of a constitution in which kneading is carried out while in a pressing state during the initial phase, and kneading is carried out while in a nonpressing state during the middle phase and/or final phase, at Operation K1. However, the foregoing embodiment is not limited to this constitution. For example, kneading may be carried out while in a nonpressing state from the initial phase through the final phase at Operation K1.

The foregoing embodiment was described in terms of a constitution in which kneading temperature is controlled at Operation K3. However, the foregoing embodiment is not limited to this constitution. For example, kneading temperature need not be controlled at Operation K3.

The foregoing embodiment was described in terms of a constitution in which control of kneading temperature is carried out by means of the rotational speed of rotor 3 at Operation K3. However, the foregoing embodiment is not limited to this constitution. For example, control of kneading temperature may be carried out by means of the temperature of a heating/cooling medium that flows through a jacket (not shown) at internal kneader 1.

The foregoing embodiment was described in terms of a constitution in which control of kneading temperature is carried out based on PID control at Operation K3. However, the foregoing embodiment is not limited to this constitution. Control of kneading temperature may be carried out based on a control method other than PID control.

The foregoing embodiment was described in terms of a constitution in which a rubber mixture and a vulcanizing-type compounding ingredient are kneaded to obtain a rubber composition. However, the foregoing embodiment is not limited to this constitution. For example, the rubber mixture may be deemed to be the rubber composition.

### WORKING EXAMPLES

Working examples in accordance with the present invention are described below.

The raw materials and reagents that were used at the Working Examples are indicated below.

| | |
|---|---|
| SBR | “SBR 1502” manufactured by JSR Corporation |
| Modified solution | “HPR 350” manufactured by JSR Corporation |
| polymerization SBR | |
| Silica | “Nipsil AQ” manufactured by Tosoh Silica |
| | Corporation |
| Silane coupling agent | “Si 75” manufactured by Degussa |
| Stearic acid | “LUNAC S-20” manufactured by Kao |
| | Corporation |
| Carbon black | “N339 SEAST KH” manufactured by Tokai |
| | Carbon Co., Ltd. |
| Oil | “Process NC140” manufactured by JX Nippon Oil |
| Zinc oxide | “Zinc Oxide Variety No. 2” manufactured by |
| | Mitsui Mining & Smelting Co., Ltd. |
| Antioxidant | “Antigen 6C” manufactured by manufactured by |
| | Sumitomo Chemical Co., Ltd. |
| Sulfur | “5% Oil Treated Sulfur” manufactured by |
| | Tsurumi Chemical Industry Co., Ltd. |
| Vulcanization | “Sanceler DM-G” manufactured by Sanshin |
| Accelerator 1 | Chemical Industry Co., Ltd. |
| Vulcanization | “Soxinol CZ” manufactured by Sumitomo |
| Accelerator 2 | Chemical Co., Ltd. |

TABLE 1

| | | First | |
|---|---|---|---|
| | | Kneading | Final |
| | | Stage | Stage |
| Blended | SBR | 40.0 | — |
| amount | Modified solution | 60.0 | — |
| parts by | polymerization SBR | | |
| mass | Silica | 100.0 | — |
| | Silane coupling agent | 9.0 | — |
| | Stearic acid | 2.0 | — |
| | Carbon black | 5.0 | — |
| | Oil | 32.0 | — |
| | Zinc oxide | 2.0 | — |
| | Antioxidant | 2.0 | — |
| | Sulfur | — | 2.1 |
| | Vulcanization Accelerator 1 | — | 2.2 |
| | Vulcanization Accelerator 2 | — | 1.7 |

### Preparation of Unvulcanized Rubber at Comparative Example 1

Rubber and compounding ingredients in accordance with TABLE 1 were fed into a Banbury mixer, were kneaded without carrying out PID control, and the mixture was discharged therefrom at 160° C. (first kneading stage). During the first kneading stage, kneading was carried out while in a state in which a downward force was exerted thereon by the ram; i.e., while in a pressing state. The mixture obtained at the first kneading stage was rekneaded in the Banbury mixer without carrying out PID control, and this was discharged therefrom at 160° C. (second kneading stage). The mixture obtained at the second kneading stage was rekneaded in the Banbury mixer without carrying out PID control, and this was discharged therefrom at 160° C. (third kneading stage). The mixture obtained at the third kneading stage and sulfur and vulcanization accelerator were kneaded to obtain unvulcanized rubber (final stage).

### Preparation of Unvulcanized Rubber at Comparative Example 2

Rubber and compounding ingredients in accordance with TABLE 1 were fed into a Banbury mixer, these were kneaded while carrying out PID control in one step in accordance with TABLE 2, and the mixture was discharged therefrom at 160° C. (first kneading stage). That is, kneading was carried out for 180 seconds at a target temperature of 150° C., and the mixture was discharged therefrom at 160° C. During the first kneading stage, kneading was carried out while in a state in which a downward force was exerted thereon by the ram; i.e., while in a pressing state. The mixture obtained at the first kneading stage was rekneaded in the Banbury mixer without carrying out PID control, and this was discharged therefrom at 160° C. (second kneading stage). Following rekneading, the mixture and sulfur and vulcanization accelerator were kneaded to obtain unvulcanized rubber (final stage).

### Preparation of Unvulcanized Rubber at Comparative Example 3

Rubber and compounding ingredients in accordance with TABLE 1 were fed into a Banbury mixer, these were kneaded while carrying out PID control in one step in accordance with TABLE 2, and the mixture was discharged therefrom at 160° C. (first kneading stage). That is, kneading was carried out for 80 seconds at a target temperature of 130° C., and the mixture was discharged therefrom at 160° C. During the first kneading stage, kneading was carried out while in a state in which a downward force was exerted thereon by the ram; i.e., while in a pressing state. The mixture obtained at the first kneading stage was rekneaded in the Banbury mixer without carrying out PID control, and this was discharged therefrom at 160° C. (second kneading stage). Following rekneading, the mixture and sulfur and vulcanization accelerator were kneaded to obtain unvulcanized rubber (final stage).

### Preparation of Unvulcanized Rubber at Comparative Example 4

Rubber and compounding ingredients in accordance with TABLE 1 were fed into a Banbury mixer, these were kneaded while carrying out PID control in two steps in accordance with TABLE 2, and the mixture was discharged therefrom at 160° C. (first kneading stage). That is, kneading was carried out for 80 seconds at a target temperature of 130° C., kneading was then carried out for 100 seconds at a target temperature of 150° C., and the mixture was discharged therefrom at 160° C. During the first kneading stage, kneading was carried out while in a state in which a downward force was exerted thereon by the ram; i.e., while in a pressing state. The mixture obtained at the first kneading stage was rekneaded in the Banbury mixer without carrying out PID control, and this was discharged therefrom at 160° C. (second kneading stage). Following rekneading, the mixture and sulfur and vulcanization accelerator were kneaded to obtain unvulcanized rubber (final stage).

### Preparation of Unvulcanized Rubber at Working Example 1

Rubber and compounding ingredients in accordance with TABLE 1 were fed into a Banbury mixer, these were kneaded while carrying out PID control in two steps in accordance with TABLE 2, and the mixture was discharged therefrom at 160° C. (first kneading stage). That is, kneading was carried out for 80 seconds at a target temperature of 130° C., kneading was then carried out for 100 seconds at a target temperature of 150° C., and the mixture was discharged therefrom at 160° C. Kneading was carried out with the ram in its raised state (i.e., a nonpressing state) for only 50 seconds of the final phase of the 80-second first control time during the first kneading stage. At other times, kneading was carried out while in a state in which a downward force was exerted thereon by the ram; i.e., while in a pressing state. The mixture obtained at the first kneading stage was rekneaded in the Banbury mixer without carrying out PID control, and this was discharged therefrom at 160° C. (second kneading stage). Following rekneading, the mixture and sulfur and vulcanization accelerator were kneaded to obtain unvulcanized rubber (final stage).

### Preparation of Unvulcanized Rubber at Working Example 2

Except for the fact that kneading was carried out with the ram in its raised state (i.e., a nonpressing state) for only 10 seconds of the final phase of the 80-second first control time during the first kneading stage, unvulcanized rubber was obtained in accordance with the same method as at Working Example 1.

### Preparation of Unvulcanized Rubber at Working Example 3

Except for the fact that kneading was carried out with the ram in its raised state (i.e., a nonpressing state) for only 70 seconds of the final phase of the 80-second first control time during the first kneading stage, unvulcanized rubber was obtained in accordance with the same method as at Working Example 1.

### Preparation of Unvulcanized Rubber at Working Example 4

Except for the fact that kneading was carried out while in a state in which a downward force was exerted thereon by the ram, i.e., a pressing state, for 15 seconds in the initial phase and 15 seconds in the final phase, and the fact that kneading was carried out with the ram in its raised state (i.e., a nonpressing state) for 50 seconds in the middle phase, of the 80-second first control time during the first kneading stage, unvulcanized rubber was obtained in accordance with the same method as at Working Example 1.

### Preparation of Unvulcanized Rubber at Working Example 5

Except for the fact that the ram was repeatedly lowered and raised so as to create an intermittent nonpressing state during the 80-second first control time of the first kneading stage, unvulcanized rubber was obtained in accordance with the same method as at Working Example 1. A nonpressing state existed for a total of 50 seconds during the 80-second first control time.

### Preparation of Vulcanized Rubber

The unvulcanized rubber was vulcanized for 30 minutes at 150° C. to obtain vulcanized rubber.

### Energy Consumption (Electric Power)

The amount of electric power consumed from the first kneading stage to the final stage at each of the Examples is shown at TABLE 2 as indexed relative to a value of 100 for the electric power at Comparative Example 1. The smaller the index the lower the electric power and smaller the energy consumption.

### Mooney Viscosity

A rotorless Mooney measurement apparatus manufactured by Toyo Seiki Seisaku-sho, Ltd., was used to measure Mooney viscosity of the unvulcanized rubber in accordance with JIS K-6300. To measure Mooney viscosity, unvulcanized rubber was preheated at 100° C. for 1 minute, following which the rotor was made to rotate, the value of the torque 4 minutes after the start of rotation of the rotor being recorded in Mooney units. The Mooney viscosities of the respective Examples are shown at TABLE 2 as indexed relative to a value of 100 for the Mooney viscosity obtained at Comparative Example 1. The smaller the index the lower the Mooney viscosity and the more excellent the workability.

### Wet Braking Performance

A Rüpke rebound resilience testing apparatus was used to measure rebound resilience (%) under conditions of 23° C. in accordance with JIS K6255. The reciprocals (reciprocals of rebound resiliences) for the respective Examples are shown at TABLE 2 as indexed relative to a value of 100 for the reciprocal of the rebound resilience obtained at Comparative Example 1. The higher the index the more excellent the wet braking performance.

### Ability to Achieve Reduced Fuel Consumption

A viscoelasticity testing machine manufactured by Toyo Seiki Seisaku-sho, Ltd., was used to measure tans of the vulcanized rubber in accordance with JIS K-6394. tanδ was measured under conditions of frequency 10 Hz, dynamic strain 1.0%, temperature 60° C., and static strain (initial strain) 10%. tans of the respective Examples are shown at TABLE 2 as indexed relative to a value of 100 for the tans obtained at Comparative Example 1. The smaller the index the lower the tans and the more excellent the ability to achieve reduced fuel consumption.

TABLE 2

| | | Comparative | Comparative | Comparative | Comparative | Working | Working | Working | Working | Working |
|---|---|---|---|---|---|---|---|---|---|---|
| | | Example | Example | Example | Example | Example | Example | Example | Example | Example |
| | | 1 | 2 | 3 | 4 | 1 | 2 | 3 | 4 | 5 |
| First | First control | — | — | 130 | 130 | 130 | 130 | 130 | 125 | 125 |
| kneading | temperature ° C. | | | | | | | | | |
| stage | Second control | — | 150 | — | 150 | 150 | 150 | 150 | 150 | 150 |
| | temperature ° C. | | | | | | | | | |
| | First control time | — | — | 80 | 80 | 80 | 80 | 80 | 80 | 80 |
| | seconds | | | | | | | | | |
| | Second control | — | 180 | — | 100 | 100 | 100 | 100 | 100 | 100 |
| | time seconds | | | | | | | | | |
| | Time during which | — | — | — | — | 50 | 10 | 70 | 50 | 50 |
| | ram in nonpressing | | | | | | | | | |
| | state seconds | | | | | | | | | |
| | Discharge | 160 | 160 | 160 | 160 | 160 | 160 | 160 | 160 | 160 |
| | temperature ° C. | | | | | | | | | |
| Second kneading stage | | Yes | Yes | Yes | Yes | Yes | Yes | Yes | Yes | Yes |
| (rekneading) | | | | | | | | | | |
| Third kneading stage | | Yes | No | No | No | No | No | No | No | No |
| (rekneading) | | | | | | | | | | |
| Evaluation | Energy consumption | 100 | 96 | 98 | 95 | 87 | 92 | 85 | 88 | 90 |
| | (electric power) | | | | | | | | | |
| | Mooney viscosity | 100 | 99 | 97 | 89 | 83 | 88 | 83 | 82 | 81 |
| | Wet braking | 100 | 102 | 100 | 104 | 107 | 105 | 108 | 106 | 110 |
| | performance | | | | | | | | | |
| | Ability to achieve | 100 | 98 | 97 | 89 | 83 | 87 | 80 | 83 | 80 |
| | reduced fuel | | | | | | | | | |
| | consumption | | | | | | | | | |

At TABLE 2, where it is indicated that PID control was carried out in one step or in two steps during the first kneading stage, this refers to PID control that was initiated at the point in time when the measured temperature reached the target temperature. During this PID control, the rotational speed of the rotor was controlled.

Whereas reaction of silane coupling agent (“S1 75” manufactured by Degussa) with silica barely proceeded at all at 130° C. but reaction with silica proceeded at 150° C., creating a state in which the ram was not pressing thereon for a prescribed time when kneading was carried out while temperature was held at 130° C. or 125° C. permitted improvement in terms of wet braking performance and ability to achieve reduced heat generation and also permitted reduction in Mooney viscosity (see Comparative Example 4 and Working Examples 1-5; see especially Comparative Example 4 and Working Examples 1-3). In addition, it was also possible to reduce consumption of energy (specifically, electric power) that had to be consumed to manufacture the rubber composition (see Comparative Example 4 and Working Examples 1-5; see especially Comparative Example 4 and Working Examples 1-3). This is thought to be due to a reduced tendency for a torque to be exerted thereon when in a nonpressing state than when in a pressing state.

Moreover, because it was possible at least where PID control carried out in one step was employed to prolong the kneading time, this made it possible to reduce the number of times that rekneading had to be carried out, and consequently made it possible to achieve reduction in the consumption of energy (specifically, electric power) that had to be consumed to manufacture the rubber composition.

### EXPLANATION OF REFERENCE NUMERALS

1 . . . internal kneader; 2 . . . casing; 2a . . . opening portion; 3 . . . rotor; 4 . . . kneading chamber; 5 . . . neck portion; 6 . . . inlet port; 7 . . . ram; 8 . . . shaft; 9 . . . drop door; 11 . . . controller; 13 . . . temperature sensor

1. A rubber composition manufacturing method comprising an operation in which at least rubber, silica, and silane coupling agent are kneaded in an internal kneader while kneading temperature is controlled so as to suppress occurrence of a coupling reaction between the silica and the silane coupling agent, wherein
the internal kneader is equipped with a kneading chamber, a neck portion which is located above the kneading chamber, and a ram which is capable of moving vertically through a space within the neck portion; and
for at least a portion of time during which the operation is being carried out, at least the rubber, the silica, and the silane coupling agent are kneaded while the ram is in a nonpressing state.

2. The rubber composition manufacturing method according to claim 1 wherein the portion of time is not less than 10 seconds.

3. The rubber composition manufacturing method according to claim 1 wherein
the internal kneader is equipped with a rotor at the kneading chamber; and
at the operation, rotational speed of the rotor is controlled by means of PID control to cause the kneading temperature to be a target temperature.

4. The rubber composition manufacturing method according to claim 1 further comprising an operation in which kneading is carried out while kneading temperature is controlled so as to cause the coupling reaction to proceed.

5. The rubber composition manufacturing method according to claim 1 wherein, during the operation in which kneading is carried out while kneading temperature is controlled so as to suppress occurrence of the coupling reaction, kneading is carried out so as to cause kneading temperature to be held constant.

6. The rubber composition manufacturing method according to claim 1 further comprising an operation in which kneading is carried out at the internal kneader while kneading temperature is controlled so as to cause the coupling reaction to proceed;
wherein, during the operation in which kneading is carried out while kneading temperature is controlled so as to cause the coupling reaction to proceed, kneading is carried out so as to cause kneading temperature to be held constant.

7. The rubber composition manufacturing method according to claim 1 further comprising an operation in which kneading is carried out at the internal kneader while kneading temperature is controlled so as to cause the coupling reaction to proceed;
wherein, between the operation in which kneading is carried out while kneading temperature is controlled so as to suppress occurrence of the coupling reaction and the operation in which kneading is carried out while kneading temperature is controlled so as to cause the coupling reaction to proceed, neither the rubber, nor the silica, nor the silane coupling agent is discharged from the internal kneader.

8. The rubber composition manufacturing method according to claim 1 wherein the portion of time is not less than 30 seconds.

9. The rubber composition manufacturing method according to claim 1 wherein the portion of time is not less than 50 seconds.

10. The rubber composition manufacturing method according to claim 1 wherein, during the operation in which kneading is carried out while kneading temperature is controlled so as to suppress occurrence of the coupling reaction, at least the rubber, the silica, the silane coupling agent, and carbon black are kneaded.

11. The rubber composition manufacturing method according to claim 1 wherein, during the operation in which kneading is carried out while kneading temperature is controlled so as to suppress occurrence of the coupling reaction, the silica is present in an amount that is 10 parts by mass to 150 parts by mass per 100 parts by mass of the rubber.

12. The rubber composition manufacturing method according to claim 1 wherein, during the portion of time, moisture present within the kneading chamber is discharged to the exterior of the kneading chamber.

13. A tire manufacturing method comprising:
an operation in which the rubber composition manufacturing method according to claim 1 is used to prepare the rubber composition; and
an operation in which the rubber composition is used to fabricate an unvulcanized tire.

14. The tire manufacturing method according to claim 13 wherein, during the operation in which the unvulcanized tire is fabricated, the unvulcanized tire which is fabricated is equipped with a tire member comprising the rubber composition.

15. The tire manufacturing method according to claim 14 wherein the tire member is tread rubber.
